(19) United States
(12) Patent Application Publication
(10) Pub. No.: US 2012/0031927 A1
(43) Pub. Date: Feb. 9, 2012

(54) APPARATUS FOR POURING A LIQUID INTO A GLASS IN PARTICULAR WINE

(75) Inventors: Paul Rivier, Rumilly (FR); Guy Houin, Serpaize (FR)

(73) Assignee: EUROCAVE SA, Villeurbanne (FR)

(21) Appl. No.: 13/148,788

(22) PCT Filed: Feb. 10, 2010
(86) PCT No.: PCT/FR2010/050224

§ 371 Date: Oct. 7, 2011

(30) Foreign Application Priority Data
Feb. 13, 2009 (FR) 09 50915

(51) Int. Cl. B67D 1/08

(52) U.S. Cl. 222/152

(57) ABSTRACT

The invention relates to an apparatus (1) for pouring into a glass (2) in order to reduce the risks of spoiling the wine (3) poured by said apparatus. Vacuum tapping means (10) are sealingly connected to the upper portion (4A) of the vessel (4) and maintain a pressure therein which is between a first predetermined value P1 lower than the atmospheric pressure and a predetermined value P2 lower than P1, and liquid tapping means (20) are sealingly connected to the lower portion (4B) of the vessel and pump liquid from said lower portion up to an area for pouring into a glass. The vacuum tapping means includes a vacuum source (11) for lowering the pressure in the upper portion (4A) of the vessel (4) to P1 and vacuum partial-compensation means (14) adapted for feeding a gaseous fluid into the upper portion of the vessel when the pressure in said upper portion is lower than P2.

The present invention relates to an apparatus for pouring into a glass a liquid, in particular wine, contained in a container.

Due to the evolution of the consumption of wines in restaurants and bars, professionals are equipped with apparatuses making it possible to pour the wine contained in its original bottle into the glass. The wine can thus be gradually tapped from its bottle, to flow into a glass, via a pour spout or similar, whereas, generally, the bottle is kept at an optimal tasting temperature for the poured wine.

Most apparatuses of this type currently used use a pressurized gas source, so as to inject said gas into the upper part of the bottle, thereby creating a pressure therein greater than the atmospheric pressure. The pressurized gaseous atmosphere then pushes the surface of the wine contained in its bottle, forcing the wine to rise in a hose up to the pour spout. In practice, these apparatuses pose several problems. Thus, the propulsive gas is provided in the form of a bulky can that must be renewed regularly, which must be connected to the bottle of wine via several expansion valves to bring the gas to an acceptable pressure. Moreover, the extended presence of a gaseous over-pressure in the top part of the bottle of wine tends to alter the flavor of the wine, in particular for sensitive wines.

GB-A-1 415 734 proposes an apparatus for pouring an alcohol into a glass. This apparatus comprises a liquid tapping conduit, which can be connected to the bottom part of a bottle of alcohol and through which the alcohol can be pumped from said lower portion, in order to then be poured into a glass. To that end, this apparatus is associated with a special stopper that, by admitting outside air, prevents the appearance of a vacuum in the bottle. This apparatus therefore does not ensure the preservation of the flavor of the liquid.

Devices also existing making it possible to create a vacuum in an open bottle, owing to a small, portable device, which is sometimes electric. DE-A-101 44 922 provides an example. These devices are not very widespread because they are tedious to handle and their potential leaks are not automatically offset, which makes them fairly unreliable. Moreover, these devices must be neutralized and released from the bottle each time one wishes to pour a glass, then it is necessary to reactivate the devices to reestablish the vacuum, with the drawbacks mentioned above.

The aim of the present invention is to propose an apparatus for pouring into a glass, which is both economical and easy to implement, while limiting the risks of altering the liquid served by said apparatus.

To that end, the invention relates to an apparatus for pouring into a glass a liquid, in particular wine, contained in a container, as defined in claim 1.

The idea at the base of the invention is to make it possible to tap the liquid, in particular wine, contained in the container, while maintaining, above said liquid, an air pressure between the first and second predetermined values, therefore at an air pressure below the atmospheric pressure, which ensures the preservation thereof. The gradual removal of the liquid is not hindered by the presence of the partial vacuum in the upper part of the container, since the air pressure is never lowered below the second predetermined value. Thus, the careful management of the vacuum according to the invention makes it possible to do away with using a propulsion gas, which is less restrictive and more economical.

Other advantageous features of the apparatus according to the invention, considered alone or according to all technically possible combinations, are specified in dependent claims 2 to 14.

The invention will be better understood upon reading the following description, provided solely as an example and done in reference to the drawings, in which:

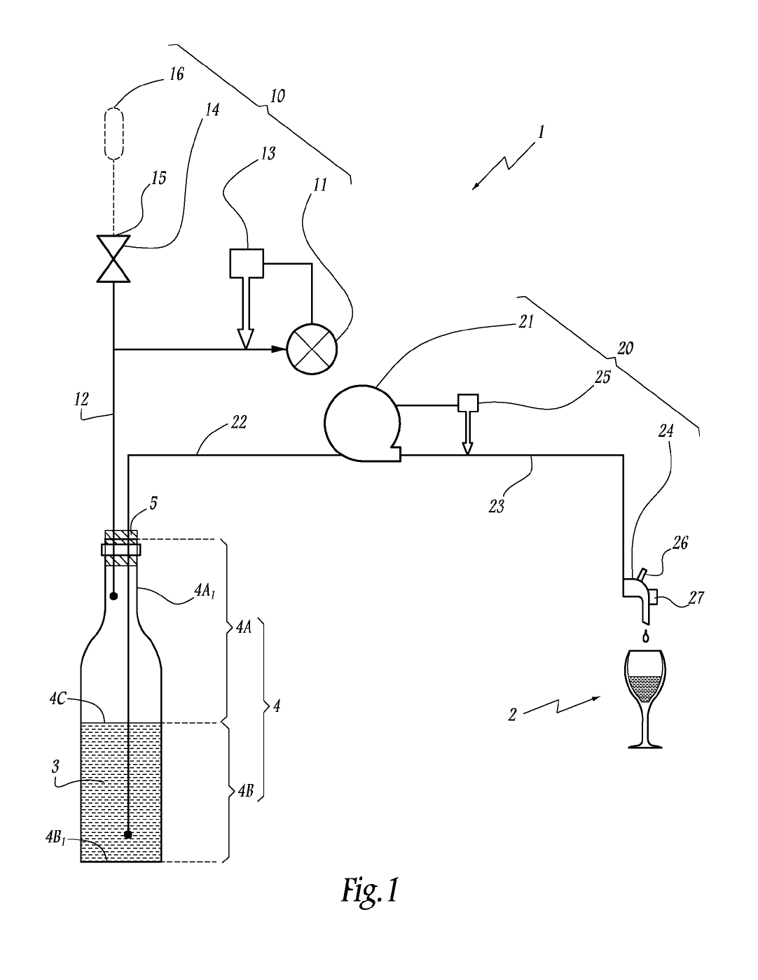

FIG. 1 is a diagram of an apparatus according to the invention, and

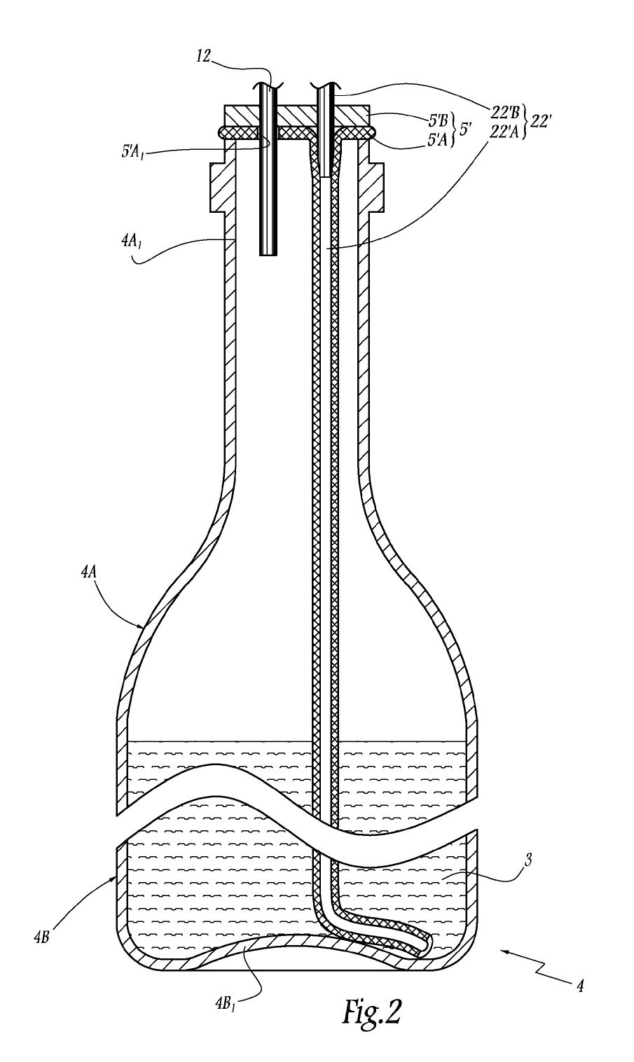

FIG. 2 is a diagram of only part of said apparatus, done according to one alternative of the invention.

FIG. 1 shows an apparatus 1 making it possible to pour wine 3 initially contained in a bottle 4, which typically corresponds to the bottle in which the wine 3 is marketed and ages, into a glass 2.

The apparatus 1 primarily comprises, on the one hand, a first assembly 10 making it possible to lower the pressure in the upper portion 4A of the bottle 4 and to maintain said pressure in a range of predetermined values, as explained in more detail below, and, on the other hand, a second assembly 20 making it possible to tap the wine 3 from the lower portion 4B of the bottle 4, up to the distributor into the glass 2, also as explained in detail later.

The first assembly 10 comprises a vacuum pump 11, for example an electric pump, connected by a conduit 12 to the upper portion 4A of the bottle 4, in particular via a sealing stopper 5 that obstructs the upper end neck 4A₁ of the bottle and which is passed all the way through by the conduit 12.

The vacuum pump 11 is associated with a control pressure switch 13 that is designed to actuate the vacuum pump as long as the gas pressure in the conduit 12 is greater than a first predetermined value designated below under reference P₁, for example equal, in absolute pressure, to 600 mbars.

The assembly 10 also comprises a valve 14 connected, on the one hand, to the conduit 12 and, on the opposite side, to a vent opening 15. The valve 14 is tared at a pressure equal to a second predetermined value, hereafter designated under reference P₂ and strictly below pressure value P₁. Thus, in the example where pressure value P₁ is equivalent to 600 mbars, this pressure value P₂ is equivalent to 550 mbars. The taring of the valve 14 is provided to keep this valve closed as long as the gas pressure in the conduit 12 is greater than pressure value P₂ while, once the pressure in said conduit 12 goes below value P₂, the valve 14 opens and thereby connects the conduit 12 to the open air, via its opening 15.

The assembly 20 includes a self-priming liquid pump 21, the inlet of which is connected to a conduit 22 that emerges in the bottom 4B₁ of the bottle 4, after having passed all the way through the sealing stopper 5, and the outlet of which is connected to another conduit 23 that emerges in a pour spout 24. This liquid pump 21 is thus able to suction the wine 3 contained in the lower portion 4B of the bottle 4, priming itself automatically, and to send it to the pour spout 24, from where it can flow into the glass 2. In practice, the liquid pump 21 is made from so-called food grade materials, i.e. materials compatible with contact with liquid food products.

As an example, the liquid pump 21 is a peristaltic pump, preferably reversible so that, with an ad hoc command, the pump can discharge into the bottle 4 the wine stagnating in the conduits 22 and 23, in particular during a prolonged period of inactivity of the pump to tap the bottle. Other embodiments can be considered regarding the liquid pump 21, such as an electromagnetic piston pump.

As a preferable option, the liquid pump 21 has a constant pumping flow rate, which makes it possible to adjust the poured quantity of wine 3 by counting time. Failing this, the liquid pump 21 is associated with a flow sensor 25 placed in series with the liquid pump, for example at the outlet thereof as shown in FIG. 1. In this case, the poured quantity of wine 3 will be determined based on measurements provided by said flow sensor 25. In practice, in the field of pouring wine by the glass, the flow rate value for the liquid pump 21 is, for example, around 1.5 l/mn. Of course, in a simplified version of the device 1 that can be considered, the pouring can be commanded only based on the arbitrary assessment of the user, without assistance from a dedicated means to measure or adjust the poured quantity of wine.

Advantageously, the pour spout 24 integrates a venting means 26 so as to prevent wine retention in the pour spout. Moreover, to also limit the stagnation of wine in the conduit 23, the latter is preferably made in the form of a flexible tubing, the shortest possible to maximally reduce the circulation path of the wine 3 between the liquid pump outlet 21 and the pour spout inlet 24.

Also advantageously, the pour spout 24 carries an actuator 27 for controlling the liquid pump 21, for example a switch-button connected to the motor of the liquid pump.

An example of operation of the apparatus 1 is as follows.

Initially, after having stopped the bottle 4 for the first time, i.e. after having removed its original stopper, typically made from cork, the neck 4A₁ of the bottle is sealingly obstructed by the stopper 5. The vacuum pump 11 and its associated pressure switch 13 are then put in use: the pressure switch 13 then measures that the pressure in the conduit 12 is greater than the pressure value P₁, since it is initially equal to the atmospheric pressure, such that it actuates the vacuum pump 11. The air pressure in the upper portion 4A of the bottle 4 decreases gradually, until it reaches the pressure value P₁, at which the pressure switch commands the stop of the vacuum pump. The wine 3 contained in the lower portion 4B of the bottle is then remarkably maintained owing to the beneficial effect of the partial vacuum reigning the upper portion 4A of the bottle.

When a user wishes to fill the glass 2 with the wine 3 contained in the bottle 4, he places his glass under the pour spout 24 then, in particular using the switch 27, he commands the actuation of the liquid pump 21. After its automatic priming, the liquid pump 21 taps the wine 3 from the bottom 4B₁ of the bottle 4, via the conduit 22, and supplies the conduit 23 with said wine. The glass 2 then gradually fills, until, at the end of a given period, either predetermined in the event the liquid pump 21 has a constant flow or determined in real-time based on flow rate measurements provided by the sensor 25, the liquid pump 21 stops. The wine 3 then stagnating in the pour spout 24, or in the conduit 23, escapes therefrom and flows freely into the glass 2, in particular under the effect of venting the means 26.

At the same time, tapping the volume of wine 3 suctioned by the liquid pump 21 into the lower portion 4B of the bottle 4 causes the lowering of the surface 4C of the wine in the bottle and, as a result, the increase in the intensity of the vacuum in the upper portion 4A of the bottle. In other words, the pressure in said upper portion 4A decreases, thereby going from the pressure value P₁ to a lower pressure value, until, if applicable, it reaches the pressure value P₂, for which the valve 14 opens. Outside air is then admitted into the upper portion 4A of the bottle 4, via the open flap 14, until the pressure in this upper portion 4A again passes above the pressure value P₂. Thus, the tared valve 14 causes a volume of air offsetting the volume of the wine 3 tapped by the liquid pump 21 to enter the upper portion 4A of the bottle 4, while maintaining the air pressure in the upper portion 4A of the bottle 4 at a value slightly greater than pressure value P₂.

If applicable, if the pressure in this upper portion 4A rises to a value greater than pressure value P₁, for example due to an excessively long response time of the valve 14, this value is detected by the pressure switch 13, which then commands the actuation of the vacuum pump 11 so as to again lower the pressure below the pressure value P₁. Furthermore, this additional action of the vacuum pump 11 can be regularly implemented via the pressure switch 13 if the sealing of the stopper 5 is not strictly perfect.

FIG. 2 shows an alternative embodiment of the conduit connecting the bottom 4B₁ of the bottle and the inlet of the liquid pump 21. Rather than producing this conduit in a single piece like the conduit 22 in the embodiment illustrated in FIG. 1, the conduit 22′ shown in FIG. 2 is formed by two distinct parts, i.e. a part 22′A placed inside the bottle 4, extending from the bottom 4B₁ to the neck 4A₁ thereof, and a part 22′B that, outside the bottle, connects the part 22′A to the inlet of the liquid pump 21. When the apparatus 1 is in service, the opening of the conduit portion 22′B, opposite the opening connected to the liquid pump 21, is sealingly connected to the opening of the portion 22′A, situated at the neck 4A₁ of the bottle 4, as in FIG. 2. In this way, the wine 3 tapped from the bottom 4B₁ under the action of the liquid pump successively supplies the portions 22′A and 22′B.

In practice, the end of the portion 22′A, opposite that emerging in the bottom 4B₁ of the bottle 4, is secured to, or even integral with, a sealing bearing discoidal element 5′A on the mouth of the neck 4A₁ of the bottle 4. The conduit portion 22′A can thus be arranged inside the bottle, without running the risk of escaping therefrom. This support element 5′A delimits a through hole 5′A₁ through which the conduit 12 is passed. Advantageously, the conduit 12 and the conduit portion 22′B are connected to a same support element 5′B which, when the apparatus 1 is in service, forms, jointly with the support element 5′A, a stopper 5′ functionally similar to the stopper 5 considered in FIG. 1.

The interest of the alternative of FIG. 2 is that, rather than having to regularly clean the entire conduit 22, the user can, upon each change of bottle 4 to be tapped, take a new conduit portion 22′A from a store of clean pieces. Thus, the conduit portion 22′, intended to be placed inside the bottles 4, can easily be changed, the user permanently having at least one clean conduit portion 22′A while the other conduit portions 22′A that have already been used can be cleaned at the same time.

Several possibilities for removable connections between the conduit portions 22′A and 22′B are possible. A first solution consists of mechanically fastening the two elements 5′A and 5′B to each other. Another solution consists of using the element 5′B to firmly press the element 5′A against the mouth of the neck 4A₁ of the bottle 4, so as to crush said element 5′A sealingly against the bottle neck. In the latter case, it may be particularly advantageous to produce the elements 5′A and 5′B according to the teachings of WO-A-2008/152235: the stopper 5′, formed by two elements 5′A and 5′B, is then similar to what is called a vacuum tapping head in the aforementioned document, with the understanding that, in the context of the present invention, the stopper 5′ accumulates a vacuum function and a wine tapping function, as previously explained. In particular, taking inspiration from the teachings of WO-A-2008/152235, the stopper 5′ can be made by providing that its element 5′B moves in a mechanically guided manner relative to the element 5′A resting on the neck 4A₁ of the bottle 4.

Various modifications and alternatives to the apparatus 1 described above can also be considered. Examples include:
Rather than venting the opening 15 of the valve 14, this opening can be connected to a dedicated gas source, typically a cartridge of a neutral gas, such as nitrogen, argon, etc., or a cartridge of carbon dioxide, as shown in broken lines in FIG. 1 under reference 16; in this way, neutral gas or carbon dioxide is injected into the upper portion 4A of the bottle 4 each time the valve 14 opens to offset a volume of wine 3 tapped by the liquid pump 21; the admission into the bottle 4 of oxygen contained in the air is thus limited, without, however, the gas source used serving to propel the wine outside the bottle, since the pressure in the upper portion 4A of said bottle is kept at a value below the atmospheric pressure, more precisely between the pressure values P₁ and P₂ as explained above; and/or
The arrangement and dimensioning of the conduits 12, 22 or 22′ and 23 are not limited to the diagrammatic illustration of FIGS. 1 and 2; for example, rather than connecting the valve 14 to the conduit 12 of the vacuum pump 11, this valve 14 can be directly sealingly connected to the upper portion 4A of the bottle 4, i.e. via its own conduit, passing all the way through the plug 5 or 5′.

1.-14. (canceled)

15. An apparatus for pouring into a glass a liquid, in particular wine, contained in a container, including:
a vacuum tapping means, adapted to be sealingly connected to the upper portion of the container and to maintain, in said upper portion, a pressure between first and second predetermined values, respectively below the atmospheric pressure and below the first predetermined value, and
a liquid tapping means, adapted to be sealingly connected to the lower portion of the container and to pump liquid from said lower portion to a pouring zone to the glass,
wherein said vacuum tapping means comprises:
a vacuum source, adapted to lower the pressure in the upper portion of the container to the first predetermined value, and
a partial vacuum compensation means, adapted to make a gaseous fluid enter the upper portion of the container when the pressure in the upper portion is below the second predetermined value.

16. The apparatus according to claim 15, wherein the vacuum source includes a vacuum pump associated with a pressure switch for controlling said vacuum pump, adapted to actuate the vacuum pump when the pressure in the upper portion of the container is above the first predetermined value.

17. The apparatus according to claim 15, wherein the partial vacuum compensating means includes a valve tared to the second predetermined value.

18. The apparatus according claim 15, wherein the partial vacuum compensating means is connected to the open air so as to cause outside air to enter the upper portion of the container.

19. The apparatus according to claim 15, wherein the partial vacuum compensating means are connected to a dedicated gas source so as to make gas enter said source in the upper portion of the container.

20. The apparatus according to claim 19, wherein said dedicated gas source is chosen amongst a neutral gas source and a carbon dioxide source.

21. The apparatus according to claim 15, wherein the liquid tapping means comprises a self-priming liquid pump.

22. The apparatus according to claim 21, wherein the liquid pump is peristaltic and reversible.

23. The apparatus according to claim 21, wherein the liquid tapping means also comprises, at the pouring zone to the glass, a pour spout connected to the outlet of the liquid pump.

24. The apparatus according to claim 23, wherein the pour spout is connected to the outlet of the liquid pump via a flexible tubing.

25. The apparatus according to claim 23, wherein the pour spout incorporates a venting means.

26. The apparatus according to claim 23, wherein the pour spout incorporates an actuator for controlling the liquid pump.

27. The apparatus according to claim 21, wherein the liquid tapping means also comprises a liquid flow sensor, placed in series with the liquid pump.

28. The apparatus according to claims 21, wherein the liquid tapping means also comprises a connecting conduit for connecting the bottom of the container with the inlet of the liquid pump, said connecting conduit including both a first portion, adapted to be introduced inside the container so as to extend between the bottom and the upper end neck of the container, and a second portion adapted to extend outside the container between the first portion and the inlet of the liquid pump, said first and second portions are designed to be removably connected to each other.

29. The apparatus according to claim 28, wherein the first and second portions are designed to be connected to each other by bearing pressing the second portion against the first portion when said first portion rests on the neck of the container.

30. The apparatus according to claim 28, wherein the first and second portions are designed to be connected to each other by fastening one on the other.
